(19) United States
(12) Patent Application Publication
(10) Pub. No.: US 2003/0210500 A1
(43) Pub. Date: Nov. 13, 2003

(54) Disc drive inertia latch with a wind vane

(75) Inventors: Yiren Hong, Singapore (SG); TakKoon Ooi, Singapore (SG); ChorShan Cheng, Singapore (SG); YongJie Tang, Singapore (SG)

Correspondence Address: John R. Wahl, Merchant & Gould, P.C., P.O. Box 2903, Minneapolis, MN, 55402-0903, US

(73) Assignee: Seagate Technology LLC

(21) Appl. No.: 10/354,792

(22) Filed: Jan. 29, 2003

Related U.S. Application Data
(60) Provisional application No. 60/379,632, filed on May 9, 2002.

(51) Int. Cl. G06F 12/00; G11B 5/54

(52) U.S. Cl. 360/256.1; 711/120

(57) ABSTRACT

A latch apparatus for use in a disc drive includes a pivot portion adapted to be rotatably mounted in the disc drive, such that the pivot portion is rotatable between latched and unlatched positions. A latch arm attached to the pivot portion is adapted to restrict movement of an actuator arm when the pivot portion is in the latched position and is adapted to avoid restricting movement of the actuator arm when the pivot portion is in the unlatched position. The latch apparatus also includes a biasing mechanism attached to the pivot portion. The biasing mechanism is adapted to continually bias the pivot portion toward the unlatched position when the pivot portion is mounted in the disc drive. A wind arm attached to the pivot portion is positioned so that a wind produced by spinning the data storage disc pushes against the wind arm and thereby biases the pivot portion toward the unlatched position when the pivot portion is mounted in the disc drive.

### RELATED APPLICATIONS

This application claims priority of U.S. provisional application Serial No. 60/379,632, filed May 9, 2002.

### FIELD OF THE INVENTION

This application relates generally to disc drives and more particularly to a disc drive inertia latch with a wind vane.

### BACKGROUND OF THE INVENTION

When a disc drive is not in operation, the actuator, which carries the read/write head, is typically parked, either within a landing zone with its read/write head resting directly on the disc surface or at a park ramp located off the disc surface. Latches are often used for restraining or preventing undesirable movement by a parked actuator.

External shocks to the disc drive tend to cause the actuator to swing from the park ramp or the landing zone onto the data zone of the disc, resulting in the read/write head coming into abrasive contact with the disc surface and creating possibly irreparable damage to the data stored on the disc. This is particularly true of clockwise or counter-clockwise shocks, depending on the design and relative position of the disc drive components. While latches are designed to prevent actuator movements resulting from external shocks, many latches have limited success in either low, medium, or high shock levels.

The reliability of the actuator latching system can be critical to maintaining the data integrity of a disc drive. Accordingly there is a need for an improved latching system which is more reliable over a wide range of shock levels, particularly as disc drives are incorporated into portable devices which significantly increases the risk of a disc drive experiencing an externally induced high rotational shock. The present invention provides a solution to this and other problems, and offers other advantages over the prior art.

### SUMMARY OF THE INVENTION

Against this backdrop the present invention has been developed. An embodiment of the present invention is a latch apparatus for use in a disc drive. The latch apparatus includes a pivot portion adapted to be rotatably mounted in the disc drive, such that the pivot portion is rotatable between latched and unlatched positions. A latch arm attached to the pivot portion is adapted to restrict movement of an actuator arm when the pivot portion is in the latched position and is adapted to avoid restricting movement of the actuator arm when the pivot portion is in the unlatched position. The latch apparatus also includes a biasing mechanism attached to the pivot portion. The biasing mechanism is adapted to continually bias the pivot portion toward the unlatched position when the pivot portion is mounted in the disc drive. A wind arm attached to the pivot portion is positioned so that a wind produced by spinning the data storage disc pushes against the wind arm and thereby biases the pivot portion toward the unlatched position when the pivot portion is mounted in the disc drive. Thus, the biasing mechanism and the wind arm both bias the pivot portion toward the unlatched position.

Stated another way, an embodiment of the present invention is a disc drive that includes a data storage disc rotatably mounted on a spin motor fastened to a base and an actuator assembly mounted on the base adjacent the data storage disc for pivoting an actuator arm over a surface of the data storage disc. The disc drive also includes a pivot mounted in the disc drive adjacent the disc, the pivot being rotatable between latched and unlatched positions. A latch arm attached to the pivot engages the actuator assembly and thereby restricts movement of the actuator arm when the pivot is in the latched position and avoids restricting movement of the actuator arm when the pivot is in the unlatched position. A biasing mechanism attached to the pivot continually biases the pivot toward the unlatched position, and a wind vane attached to the pivot is positioned so that a wind produced by spinning the data storage disc pushes against the wind vane and thereby biases the pivot toward the unlatched position.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the primary internal components with the heads parked and the inertia latch apparatus in the unlatched position.

FIG. 2 is a view similar to FIG. 1, but with the inertia latch in the latched position.

FIG. 3 is a view similar to FIG. 1, but with the heads being parked.

### DETAILED DESCRIPTION

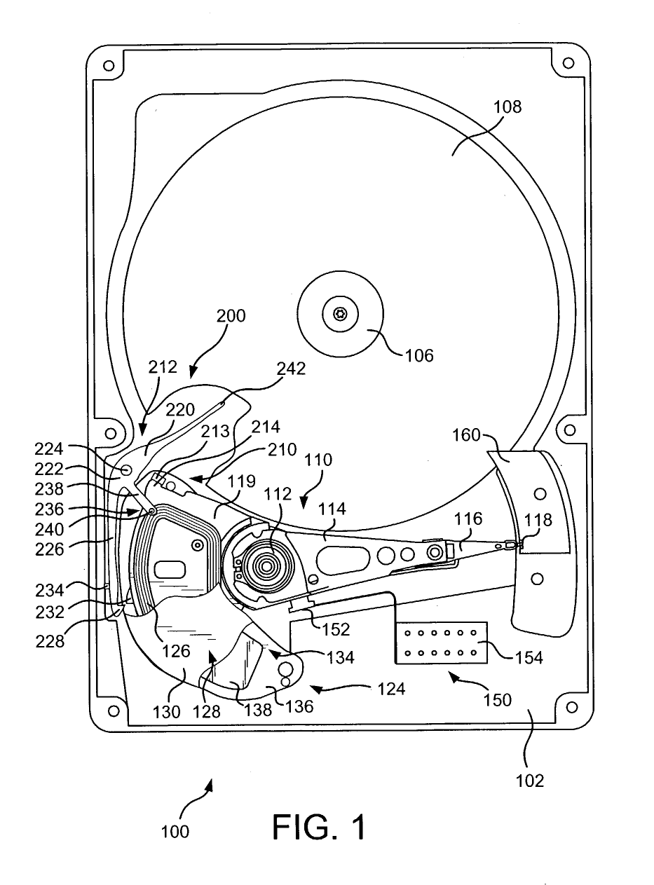

A disc drive 100 constructed in accordance with a preferred embodiment of the present invention is shown in FIGS. 1-3. The disc drive 100 includes a base 102 to which various components of the disc drive 100 are mounted. A top cover (not shown) cooperates with the base 102 to form an internal, sealed environment for the disc drive in a conventional manner. The components include a spindle motor 106, which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118, which includes an air bearing slider enabling the head 118 to fly in close proximity above the corresponding surface of the associated disc 108. The actuator assembly 110 also includes a yoke 119 that extends from the bearing shaft assembly 110 in a direction opposite from the actuator arms 114.

During a seek operation, the track position of the heads 118 is controlled through the use of a voice coil motor 124, which typically includes a coil 126 supported by the yoke 119. The voice coil motor 124 also includes a top magnetic pole 128 that includes a top pole plate 130, which is joined with a permanent top pole magnet (not shown). A bottom magnetic pole 134 includes a bottom pole plate 136 that is joined with a bottom pole magnet 138. The top magnetic pole 128 and the bottom magnetic pole 134 cooperate to establish a magnetic field in which the coil 126 is immersed. The controlled application of current to the coil 126 causes magnetic interaction between the magnetic poles 128 and 134 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

A flex assembly 150 provides the requisite electrical connection paths for the actuator assembly 110 while allowing pivotal movement of the actuator assembly 110 during operation. The flex assembly includes a printed circuit board 152 to which head wires (not shown) are connected; the head wires being routed along the actuator arms 114 and the flexures 116 to the heads 118. The printed circuit board 152 typically includes circuitry for controlling the write currents applied to the heads 118 during a write operation and a preamplifier for amplifying read signals generated by the heads 118 during a read operation. The flex assembly terminates at a flex bracket 154 for communication through the base deck 102 to a disc drive printed circuit board (not shown) mounted to the bottom side of the disc drive 100.

The spindle motor 106 is typically de-energized when the disc drive 100 is not in use for extended periods of time. The heads 118 are moved off the surfaces of the discs 108 and onto park ramps 160 near the outer diameter of the discs 108 when the drive motor is de-energized. Notably, the invention may also be used in an arrangement where the heads 118 are parked over park zones of the discs 108 near the inner or outer diameter of the discs 108.

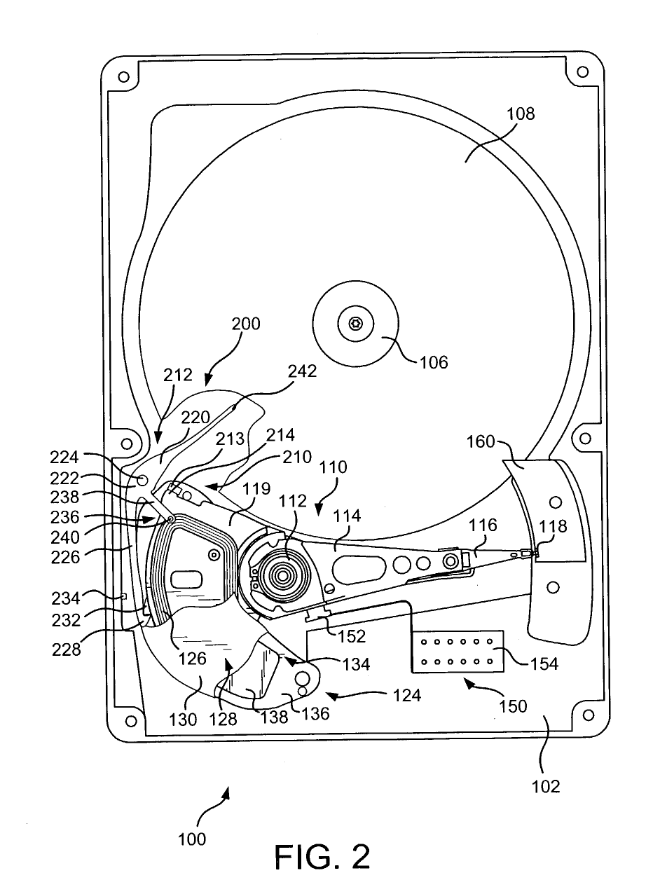

A latch apparatus 200 secures the heads 118 on the park ramps 160 and prevents inadvertent rotation of the actuator assembly 110 when the heads are parked. The latch apparatus 200 preferably includes a magnetic latch apparatus 210 and an inertia latch apparatus 212. The inertia latch apparatus 212 is normally in an unlatched position shown in FIG. 1, allowing the actuator assembly 110 to rotate, whether the heads 118 are parked or not. However, the magnetic latch apparatus 210 prevents rotation of the actuator assembly 110 and secures the heads 118 on the park ramps 160. Nevertheless, a significant shock to the disc drive 100 can dislodge the actuator assembly 110 from the magnetic latch apparatus 210. However, such a shock also rotates the inertia latch apparatus 212 counter-clockwise from its normally unlatched position shown in FIG. 1 to its latched position shown in FIG. 2. Accordingly, the magnetic latch apparatus 210 secures the actuator assembly 110 in the parked position in the absence of significant shocks to the disc drive 100 and the inertia latch apparatus 212 secures the actuator assembly 110 in the parked position during significant shocks to the disc drive 100. Thus, the inertia latch apparatus 212 and the magnetic latch apparatus 210 combine to secure the heads 118 on the park ramps 160 during non-operation of the disc drive 100 whether or not the disc drive 100 receives significant shocks.

More specifically, the magnetic latch apparatus 210 preferably includes a metal column 213 that connects the top pole 128 and the bottom pole 134 of the voice coil motor 124 on an end of the top and bottom poles 128 and 134 that is opposite from the flex bracket 154. The metal column 213 is thereby magnetized. The magnetic latch apparatus 210 also includes a metal member 214 mounted on a side of the yoke 119 facing the metal column 213. When the heads 118 are parked on the park ramps 160, the metal member 213 is attracted by the magnetized column 213 and preferably abuts the magnetized column 213. The magnetic latch apparatus 210 thus holds the actuator assembly 110 in place until a sufficient force acts on the actuator assembly 110 to overcome the attractive force of the magnetized column 213 on the metal member 214, such as a force produced by the voice coil motor 124 to unpark the heads 118. The latching force of the magnetic latch apparatus 210 is typically small enough to allow the voice coil motor 124 to unlatch the actuator assembly, but also small enough that a shock to the disc drive 100 can unlatch the actuator assembly and damage the heads 118 and/or the discs 108. The magnetic latch apparatus 210 can have many different configurations. For example, it could include a magnet that is independent of the magnetic poles 128 and 134 of the voice coil motor 124.

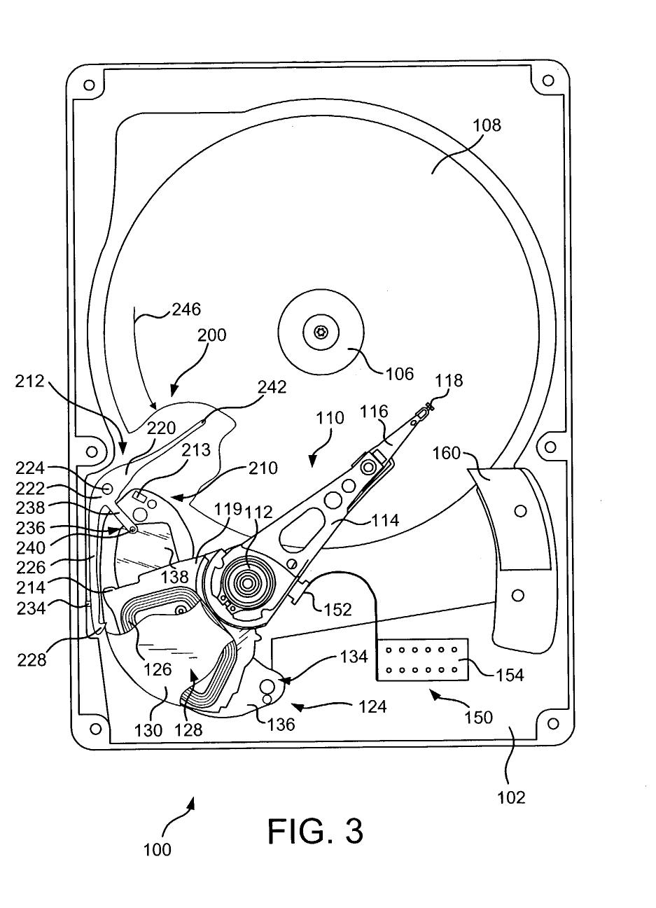

The inertia latch apparatus 212 includes a unitary member 220 that has a pivot or pivot portion 222 mounted to the base 102 adjacent the magnetized column 213. The pivot portion 222 pivots about a pin or fastener 224 between an unlatched position shown in FIGS. 1 and 3 and a latched position shown in FIG. 2. More specifically, the unitary member 220 is balanced and weighted so that the force from a shock that would be sufficient to pivot the actuator assembly 110 away from the parked position pivots the unitary member 220 to the latched position.

The unitary member 220 preferably also includes a latch arm 226 that extends from the pivot portion 222 along the circumferential path of the outer periphery of the yoke 119. The latch arm 226 has a hook finger 228 that projects from the distal end of the latch arm 226 toward the actuator assembly 110. An actuator hook 232 extends from the outer periphery of the yoke 119 toward the latch arm 226 when the actuator assembly 110 is positioned so that the heads 118 are parked on the park ramps 160 as shown in FIG. 1. The actuator hook 232 and the hook finger 228 of the latch arm 226 are preferably positioned so that when the actuator assembly 110 is rotated so that the heads 118 are parked on the park ramps 160 and the pivot portion 222 is rotated so that the unitary member 220 is in the latched position shown in FIG. 2, the hook finger 228 of the latch arm 226 engages the actuator hook 232 and thereby restricts the rotation of the actuator assembly 110, preventing the actuator assembly 110 from pivoting away from the parked position. The latch arm 226 rests against a stop 234 when it is in the unlatched position shown in FIGS. 1 and 3. The stop 234 prevents the latch arm 226 from pivoting too far from the actuator assembly 110 so that the latch arm 226 can quickly rotate from the unlatched position of FIG. 1 to the latched position of FIG. 2.

A biasing mechanism 236 includes a bias arm 238 that is part of the unitary member 220 and that preferably extends from the pivot portion 222 and terminates within the magnetic field formed between the top magnetic pole 128 and the bottom magnetic pole 134 of the voice coil motor 124. The biasing mechanism 236 also includes a ferromagnetic member 240, which is preferably a metal ball. The metal ball 240 is carried on the terminal end of the bias arm 238 within the magnetic field of the voice coil motor 124. The magnetic field of the voice coil motor 124 continually biases the metal ball 240, providing a restore force, which biases the unitary member 220 toward the unlatched position shown in FIGS. 1 and 3 and away from the latched position shown in FIG. 2. The force on the metal ball 240 may vary somewhat depending on the position of the metal ball 240 within the magnetic field of the voice coil motor 124, but the force preferably continually acts on the metal ball 240. The biasing mechanism 236 thus continually biases the unitary member 220 toward the unlatched position.

Additionally, the unitary member 220 includes a wind arm or wind vane 242 that extends from the pivot portion 222 and over the data surfaces of the discs 108 (either above or below the data surfaces of the discs 108). The wind vane 242 can extend below the lowest disc, above the highest disc, or between multiple discs. When the discs 108 are spinning as shown in FIG. 3, the spinning discs 108 produce a wind traveling in a substantially circumferential path or wind direction 246, though the path 246 does have an outward radial component. The wind is typically airflow, but it could be a flow of some other gas, such as helium or nitrogen. The wind vane 242 preferably extends perpendicular to the wind path 246 so that the wind presses against the wind vane 242 and provides an additional biasing force that biases the unitary member 220 toward the unlatched position while the discs 108 are spinning and the actuator assembly 110 is in an unparked position. This additional biasing force prevents the latch arm 226 from being inadvertently rotated to the latched position and interfering with operation of the actuator assembly 110 while the actuator assembly 110 is not in the parked position. Notably, the wind vane 242 allows this to be done without requiring a large restore force.

The restore force produced by the biasing mechanism 236 can thus be decreased with the use of the wind vane 242. This can be done, for example, by repositioning the metal ball 240 within the magnetic field or by decreasing the size of the metal ball 240. When the discs 108 are not spinning and the actuator assembly 110 is in the parked position, the smaller restore force allows the unitary member 220 to more readily and more quickly rotate from the unlatched position of FIG. 1 to the latched position of FIG. 2 when the disc drive 100 receives a significant shock. This increases the reliability of the inertia latch apparatus 212 and the reliability of the overall latch apparatus 200, thereby providing additional assurance that the heads 118 will not inadvertently pivot away from their parked position when the discs 108 are not spinning at operational speed.

An embodiment of the present invention may be described as a latch apparatus (such as 200) for use in a disc drive (such as 100). The latch apparatus includes a pivot portion (such as 222) adapted to be rotatably mounted in the disc drive, such that the pivot portion is rotatable between latched and unlatched positions. A latch arm attached to the pivot portion is adapted to restrict movement of an actuator arm (such as 114) when the pivot portion is in the latched position and is adapted to avoid restricting movement of the actuator arm when the pivot portion is in the unlatched position. The latch apparatus also includes a biasing mechanism (such as 236) attached to the pivot portion. The biasing mechanism is adapted to continually bias the pivot portion toward the unlatched position when the pivot portion is mounted in the disc drive. A wind arm (such as 242) attached to the pivot portion is positioned so that a wind produced by spinning the data storage disc pushes against the wind arm and thereby biases the pivot portion toward the unlatched position when the pivot portion is mounted in the disc drive.

The latch apparatus may include an inertia latch apparatus (such as 212) that is adapted to overcome the bias of the biasing mechanism and rotate the pivot portion to the latched position when the pivot portion is mounted in the disc drive and the disc drive receives a sufficient shock while a data storage disc (such as 108) in the disc drive is not spinning. The latch apparatus may also include a magnetic latch (such as 210) that is adapted to restrict movement of the actuator arm when an actuator assembly (such as 110) is rotated to a parked position. Preferably, a shock to the disc drive while the disc is not spinning that is sufficient to overcome the magnetic latch is also sufficient to overcome the bias of the biasing mechanism and rotate the pivot portion to the latched position.

The wind arm preferably extends over a data surface of the disc. Moreover, the biasing mechanism preferably includes a metal member (such as 240) attached to the pivot and adapted to be positioned within a magnetic field of a voice coil motor (such as 124) in the disc drive. The pivot portion, the latch arm, and the wind arm are all preferably parts of a unitary member (such as 220). The latch arm preferably includes a hook (such as 228) adapted to engage the actuator assembly when the pivot portion is in the latched position.

An embodiment of the present invention may be alternatively described as a disc drive (such as 100) that includes a data storage disc (such as 108) rotatably mounted on a spin motor (such as 106) fastened to a base (such as 102) and an actuator assembly (such as 110) mounted on the base adjacent the data storage disc for pivoting an actuator arm (such as 114) over a surface of the data storage disc. The disc drive also includes a pivot (such as 222) mounted in the disc drive adjacent the disc, the pivot being rotatable between latched and unlatched positions. A latch arm (such as 226) attached to the pivot engages the actuator assembly and thereby restricts movement of the actuator arm when the pivot is in the latched position and avoids restricting movement of the actuator arm when the pivot is in the unlatched position. A biasing mechanism (such as 236) attached to the pivot continually biases the pivot toward the unlatched position, and a wind vane (such as 242) attached to the pivot is positioned so that a wind produced by spinning the data storage disc pushes against the wind vane and thereby biases the pivot toward the unlatched position.

An embodiment of the present invention may alternatively be described as a disc drive (such as 100) that includes a latch arm (such as 226) mounted in the disc drive adjacent a data storage disc (such as 108). The latch arm is rotatable between a latched position wherein the latch arm engages the actuator assembly and thereby restricts movement of the actuator arm and an unlatched position wherein the latch arm avoids engaging the actuator assembly and restricting movement of the actuator arm. The disc drive also includes means for continually biasing the latch arm toward the unlatched position and for utilizing a wind produced by spinning the data storage disc to provide additional biasing force toward the unlatched position when the data storage disc is spinning.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the inertia latch apparatus 212 could include multiple wind vanes, rather than the single wind vane described. Also, any suitable material could be used to manufacture the unitary member 220. Numerous other changes may be made which will readily suggest themselves to those skilled in the art and which are encompassed in the spirit of the invention disclosed and as defined in the appended claims.

What is claimed is:

1. A latch apparatus for use in a disc drive having a data storage disc rotatably mounted on a spin motor fastened to a base, and an actuator assembly mounted on the base adjacent the data storage disc for pivoting an actuator arm over a surface of the data storage disc, the latch apparatus comprising:
a pivot portion adapted to be rotatably mounted in the disc drive, such that the pivot portion is rotatable between latched and unlatched positions;
a latch arm attached to the pivot portion, the latch arm adapted to restrict movement of the actuator arm when the pivot portion is in the latched position and adapted to avoid restricting movement of the actuator arm when the pivot portion is in the unlatched position;
a biasing mechanism attached to the pivot portion, the biasing mechanism adapted to continually bias the pivot portion toward the unlatched position when the pivot portion is mounted in the disc drive; and
a wind arm attached to the pivot portion, the wind arm positioned so that a wind produced by spinning the data storage disc pushes against the wind arm and thereby biases the pivot portion toward the unlatched position when the pivot portion is mounted in the disc drive.

2. The latch of claim 1, wherein the latch apparatus comprises an inertia latch apparatus that is adapted to overcome the bias of the biasing mechanism and rotate the pivot portion to the latched position when the pivot portion is mounted in the disc drive and the disc drive receives a sufficient shock while the disc is not spinning.

3. The latch of claim 2, wherein the latch apparatus further comprises a magnetic latch that is adapted to restrict movement of the actuator arm when the actuator assembly is rotated to a parked position.

4. The latch of claim 3, wherein a shock to the disc drive while the disc is not spinning that is sufficient to overcome the magnetic latch is also sufficient to overcome the bias of the biasing mechanism and rotate the pivot portion to the latched position.

5. The latch of claim 1, wherein the wind arm extends over a data surface of the disc.

6. The latch of claim 1, wherein the biasing mechanism comprises a metal member attached to the pivot and adapted to be positioned within a magnetic field of a voice coil motor in the disc drive.

7. The latch of claim 1, wherein the pivot portion, the latch arm, and the wind arm comprise a unitary member.

8. The latch of claim 1, wherein latch arm comprises a hook adapted to engage the actuator assembly when the pivot portion is in the latched position.

9. A disc drive comprising:
a data storage disc rotatably mounted on a spin motor fastened to a base;
an actuator assembly mounted on the base adjacent the data storage disc for pivoting an actuator arm over a surface of the data storage disc;
a pivot mounted in the disc drive adjacent the disc, the pivot rotatable between latched and unlatched positions;
a latch arm attached to the pivot, the latch arm engaging the actuator assembly and thereby restricting movement of the actuator arm when the pivot is in the latched position and avoiding restricting movement of the actuator arm when the pivot is in the unlatched position;
a magnetic biasing mechanism attached to the pivot, the biasing mechanism continually biasing the pivot toward the unlatched position; and
a wind vane attached to the pivot, the wind vane positioned so that a wind produced by spinning the data storage disc pushes against the wind vane and thereby biases the pivot toward the unlatched position.

10. The disc drive of claim 9, wherein the latch arm, the biasing mechanism, and the wind vane comprise an inertia latch apparatus that is adapted to overcome the bias of the biasing mechanism and rotate the pivot to the latched position when the disc drive receives a sufficient shock while the disc is not spinning.

11. The disc drive of claim 10, wherein the latch apparatus further comprises a magnetic latch that restricts movement of the actuator arm when the actuator assembly is rotated to a parked position.

12. The disc drive of claim 11, wherein a shock to the disc drive when the disc is not spinning that is sufficient to overcome the magnetic latch is also sufficient to overcome the bias of the biasing mechanism and rotate the pivot to the latched position.

13. The disc drive of claim 11, wherein the wind vane extends over a data surface of the disc.

14. The disc drive of claim 11, wherein the biasing mechanism comprises a metal member attached to the pivot, the metal member positioned within a magnetic field of a voice coil motor in the disc drive.

15. The disc drive of claim 11, wherein the pivot, the latch arm, and the wind vane comprise a unitary member.

16. The disc drive of claim 11, wherein the latch arm comprises a hook adapted to engage the actuator assembly when the pivot is in the latched position.

17. A disc drive having a data storage disc rotatably mounted on a spin motor fastened to a base and an actuator assembly mounted on the base adjacent the data storage disc for pivoting an actuator arm over a surface of the data storage disc, the disc drive comprising
a latch arm mounted in the disc drive adjacent the disc, the latch arm rotatable between a latched position wherein the latch arm engages the actuator assembly and thereby restricts movement of the actuator arm and an unlatched position wherein the latch arm avoids engaging the actuator assembly and restricting movement of the actuator arm; and
means for continually biasing the latch arm toward the unlatched position and for utilizing a wind produced by spinning the data storage disc to provide additional biasing force toward the unlatched position when the data storage disc is spinning.

18. The disc drive of claim 17, wherein the means for continually biasing and for utilizing comprises a wind vane attached to the latch arm, the wind vane being positioned so that a wind produced by spinning the data storage disc pushes against the wind vane and thereby biases the latch arm toward the unlatched position

19. The disc drive of claim 18, wherein the means for continually biasing and for utilizing further comprises a metal member attached to the latch arm, the metal member being positioned within a magnetic field of a voice coil motor in the disc drive.

20. The latch of claim 19, wherein the latch arm, the metal member, and the wind vane comprise an inertia latch apparatus that is adapted to overcome the bias of the metal member and rotate the latch arm to the latched position when the disc drive receives a sufficient shock while the disc is not spinning.
